(19) United States
(12) Patent Application Publication
(10) Pub. No.: US 2006/0214025 A1
(43) Pub. Date: Sep. 28, 2006

(54) Shower apparatus, kit and method of using same

(76) Inventor: Andrew C. Kim, Chicago, IL (US)

Correspondence Address: JERRY RICHARD POTTS, 3248 VIA RIBERA, ESCONDIDO, CA, 92029, US

(21) Appl. No.: 11/090,600

(22) Filed: Mar. 26, 2005

(51) Int. Cl. B05B 7/26

(52) U.S. Cl. 239/310; 239/282; 239/600

(57) ABSTRACT

A shower kit and apparatus includes a showerhead coupler and a sealed flexible water chamber, which are placed in line between in a shower stall between the shower arm and the showerhead. The showerhead coupler has a water source outlet for discharging water under pressure into the flexible water chamber and a water source inlet for receiving water under pressure from the flexible water chamber. The flexible water chamber has a sufficient volume capacity to absorb and smooth out momentary fluctuations or changes in water pressure by breaking up the mass of air that would otherwise fill the shower arm into small bubbles within the volume of water contained within the flexible water chamber, which mixture of water and bubbles is then sent out to the shower head and evacuated unnoticed.

### BACKGROUND OF THE INVENTION

1. Field of the Invention

This application relates to bathroom and outdoor showers, and more particularly to the handling of water discharged from a showerhead.

2. Background of Prior Art

The negative effect of fluctuations in water pressure and temperature in bathroom shower stalls is well known in the prior art. Therefore there is a need for a new and improved shower apparatus, kit and method for helping to smooth out momentary fluctuations of water pressure and temperature relative to water being discharged from a showerhead or bathtub closure.

### BRIEF SUMMARY OF THE INVENTION

In a preferred embodiment of the invention, a shower apparatus, and retrofit kit includes a showerhead coupler and a sealed flexible water chamber, which according to a novel method of use are placed in-line in a shower stall between the shower arm and the showerhead. The showerhead coupler has a water source outlet for discharging water under pressure into the water chamber and a water source inlet for receiving water under pressure from the water chamber. The flexible water chamber has a sufficient volume capacity not only to average out temporary fluctuations in water temperature but also has sufficient volume of air to absorb and smooth out momentary fluctuations or changes in water pressure and breaks up masses of air into small unnoticed air bubbles.

### BRIEF DESCRIPTION OF THE DRAWINGS

The above mentioned features and steps of the invention and the manner of attaining them will become apparent, and the invention itself will be best understood by reference to the following description of the preferred embodiment(s) of the invention in conjunction with the accompanying drawings wherein:

FIG. 1 is a greatly reduced perspective view of a shower retrofit kit, which is constructed in accordance with an embodiment of the present invention;

FIG. 2 is a greatly reduced perspective view of a water container, which forms part of the shower retrofit kit of FIG. 1;

FIG. 3 is perspective view of the shower retrofit kit of FIG. 1, illustrating the kit assembled and installed in a conventional shower stall;

FIG. 4 is a greatly reduced perspective view of a shower apparatus, which is constructed in accordance with another embodiment of the present invention;

FIG. 5 is a top plane view of a flexible thin wall container forming part of the shower apparatus of FIG. 4;

FIG. 6 is a greatly reduced perspective view of another shower apparatus, which is constructed in accordance with yet another embodiment of the present invention; and

FIG. 7 is a greatly reduced perspective view of a conventional prior art shower stall, illustrating the shower stall shower arm and shower stall showerhead and their associated direct line water path.

### DETAILED DESCRIPTION OF THE PREFERRED EMBODIMENTS OF THE INVENTION

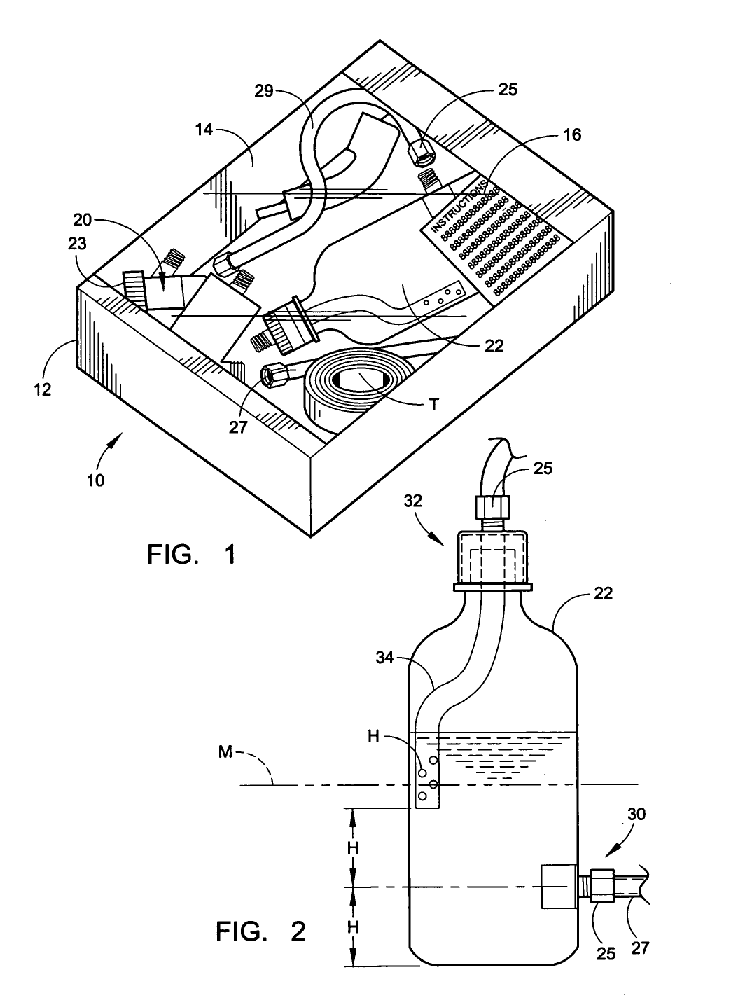

Referring now to the drawings and more particularly to FIGS. 1-3, there is illustrated a shower retrofit kit 10, which is constructed according to one of the preferred embodiment of the present invention. In this embodiment, the retrofit kit 10 is packaged in a convenient container 12 having a display window 14, which allows a purchaser to see the contents of the kit 10. This is a convenient aspect of this embodiment of the present invention, as it provides a user (not shown) with the ability to visually see the component parts of the kit 10, which in turn, allows the user to quickly and easily determine the ease in which the kit 10 may be assembled and installed for immediate use in a conventional shower stall S (FIG. 7).

As best seen in FIGS. 1-3, the shower retrofit kit 10 generally comprises a set of installation instructions 16, a water path diverter or showerhead coupler 20, a reservoir or container, such as a flexible bladder or thin-walled flexible plastic bottle 22, and a roll of plumber's tape T. The showerhead coupler 20 is an in-line coupler that breaks the water path P between the shower stall shower arm 17 and the shower stall showerhead 19 in a conventional shower stall, such as the shower stall S illustrated in FIG. 7. In this regard, the showerhead coupler 20 includes a threaded water outlet stub 24 and a threaded water inlet stub 26 which are not in fluid communication with one another but as will be explained hereinafter in greater detail, are put in fluid communication with one another via the container 22, which also buffers fluid fluctuations.

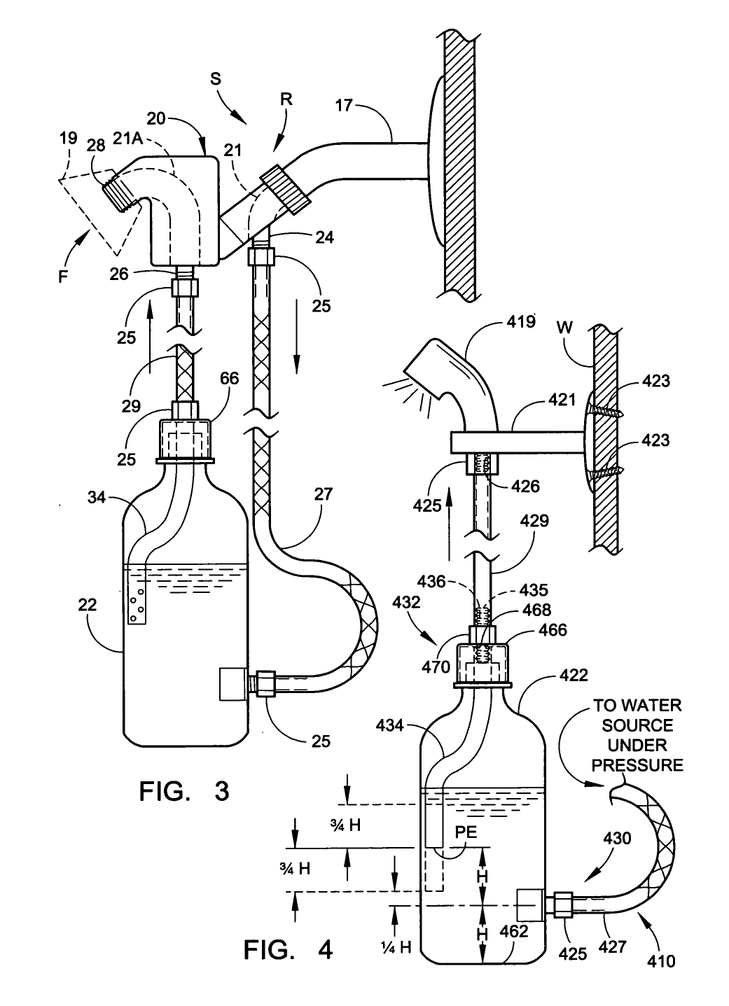

As best seen in FIG. 3, the showerhead coupler 20 is a fluid path diverter that includes an incurrent fluid path or conduit, indicated generally at 21 and an excurrent fluid path or conduit, indicated generally at 21A. The incurrent fluid path 21 and the excurrent fluid path 21A are not in fluid communication with one another. The interior conduit 21 extends from the water outlet stub 24 to a female threaded water inlet 23, formed at a rear portion of the showerhead coupler 20, indicated generally at R. The interior conduit 21A extends from the water inlet stub 26 to a male threaded water outlet stub 28 formed on a front portion of the showerhead coupler 20, indicated generally at F. In this regard, it will be understood by those skilled in the art that the showerhead coupler 20 has two completely separate and independent water paths formed by the interior conduits 21 and 21A respectively.

The threaded water outlet stub 28 is dimensioned for receiving thereon a conventional shower stall showerhead such as the showerhead 19. In order to assure that a watertight fit is achieved when the showerhead 19 is threaded onto the outlet stub 28, a piece of plumber's tape T may be wrapped around the threads of the threaded stub 28. In this manner, when the showerhead 19 is threaded onto the stub 28, the plumber's tape T will fill the gaps between the engaging threads thereby assuring that a watertight seal is form between the threads of the showerhead 19 and the threads on the threaded stub 28.

In order to help create a new water path between the shower stall shower arm 17 and the shower stall showerhead 19, and more particularly between the incurrent fluid path 21 and the excurrent fluid path 21A, the retrofit kit 10 further includes a pair of standard off the shelf wire mesh reinforced rubber hoses 27 and 29 respectively. Each individual hose, such as the hose 27, has a sufficient length to extend from the shower arm 17 to the floor or base B of the shower stall S. Also each end of each individual hose, such as the hose 27, includes a female nut-like coupler 25, which allows the hose 27 to be coupled in an airtight fit to the thin-walled plastic bottle 22, as will be explained hereinafter in greater detail. It should be noted that the hoses 27, 29 could also be made of a flexible rubber or any other resilient expandable material suitable for the passage of water under pressure.

Although in this preferred embodiment of the present invention, the hoses 27 and 29 are described as having female nut-like couplers disposed on each of their respective ends, it should be understood by those skilled in the art, that the inside diameter of each hose could be constructed to be slightly smaller than the outside diameter of the stubs 24 and 26 respectively. In this regard, the female nut-like couplers could be eliminated so that the respective hoses 27 and 29 could be pushed on to their respective stubs 24 and 26 in a friction tight fit. This simple modification helps to reduce the overall cost of the retrofit kit 10 and further helps in the ease of installation by eliminating the need of any tools. In either case, the use of the hoses 27 and 29 allows the shower stall S to undergo a do it yourself retrofit without the need of lowering the shower arm 17 or more specifically, the water outlet to the shower arm 17.

As mentioned earlier, the retrofit kit 10 includes all the necessary components to retrofit a conventional shower stall, such as the shower stall S. In this regard, the thin-walled plastic bottle 22 cooperates with the hoses 27 and 29 respectively, to help complete the creation of the new water path between the shower arm 17 and the showerhead 19. In addition to helping to complete the creation of the new water path between the shower arm 17 and the showerhead 19, the thin-walled plastic bottle 22 also functions as a water reservoir and water pressure dampener to help smooth out or even out fluctuations in water temperature and water pressure that could otherwise cause unwanted and undesired water temperature changes and air spurts from the showerhead 19.

To help facilitate placing the bottle 22 in-line between the showerhead coupler 20 and the showerhead 19, the bottle 22 generally includes a threaded sidewall inlet 30, a threaded neck or top wall outlet, indicted generally at 32 and a sealing cap 66 having a centrally disposed hole 68. The inlet 30 is designed to provide an airtight fit with the hose 27, when the hose coupler 25 is fastened to the inlet 30. The sealing cap 66 provides the bottle 22 with an airtight and watertight seal.

As best seen in FIG. 2, the bottle 22 further includes an extension member 34 that extends through the hole 68 to the interior volumetric space of the bottle 22 so that the proximal end P of the extension member 34 is disposed above the mid-line M of the bottle 22, while the distal end of the extension member 34 is disposed below the mid-line M of the bottle 22. From the foregoing, it will be understood that the nut 25 is secured to the threaded proximal end P of the extension tube and tightened against the cap 66 to secure the hose 29 and the extension tube 34 in place.

Considering now the use of the shower retrofit kit 10 to modifying a conventional shower stall S in greater detail with reference to FIGS. 1-3, a user opens the package 12 and removes the contents which includes the showerhead coupler 20, the flexible thin-walled plastic bottle 22, the two reinforced rubber hoses 27 and 29 respectively, a roll of plumber's tape T, and a set of installation instruction 18 as best seen in FIG. 1.

Following the installation instruction 18, the user removes the showerhead 19 from its in-line placement with the shower arm 17. Next the user reattaches the showerhead 19 to the water outlet stub 28 of the showerhead coupler 20 and then attaches the showerhead coupler 20 to the shower arm 17 through the female threaded inlet 23 (FIG. 1).

With the showerhead coupler 20 firmly attached to the shower arm 17, the user next creates a new water path between the shower arm 17 and the showerhead 19. In this regard, the user attaches the flexible thin-walled plastic bottle 22 in-line between the water source outlet 24 of the showerhead coupler 20, and the water source inlet 26 of the showerhead coupler 20 using hoses 27 and 29 respectively as best seen in FIG. 3.

Finally, the user turns on the water source to allow water to flow into the bottle 22. In this regard, as water enters the bottle 22, air simultaneously escapes through the hose 29, via the extension member 34, which extends into the interior of the bottle 22. Once the water level in the bottle 22 rises to a sufficient point above the distal end of the extension member 34, for example as illustrated in FIG. 2, any air remaining in the bottle 22 has no where to escape and thus, is trapped. With no immediate escape the confined spaced causes the air within the bottle 22, to compress, which in turn starts to force water up through the extension member 34, the hose 29 and finally through the showerhead 19. Once a steady state condition is reached, which happens relatively quickly, the pressure P₂ of the air within the bottle 22 is roughly related to P₁, the pressure in the extension 34 and hose 29, by Bernoulli's Law:
P₂=P₁+½ρV²+ρpgh
where ρ is equal to the density of water, V is equal to the speed of the water through the tube, h is the height of the point in the tube above the water level, and g is gravity.
Thus, the compressed air forces the water up through the tube 34, the hose 29, through the excurrent water path 21A of the water path diverter 20 and out the holes of the shower head 19.

In short then, in the steady state condition, the flow of water through the showerhead 19 is almost exactly the same as though the retrofit kit 10 had not been installed. Stated otherwise, when the fluid path diverter 20, is attached between the shower arm 17 and the showerhead 19 so that a segment of its incurrent water path 21 and a segment of its excurrent water path 21A are placed in parallel alignment with the outflow of fluid from the shower arm 17 and in fluid communication with one another via the previously described buffering arrangement (22,34), fluid fluctuations in an otherwise steady state flow of fluid are substantially unnoticeable to a user.

Now if a temperature fluctuation occurs in the incoming water flow, as often happens in older buildings due to water demands, any overly heated or hot water rush will mix with the water reservoir stored within the bottle 22 before it is discharged toward the showerhead 19. Thus, by using the shower retrofit kit 10 short burst water temperature changes (hot or cold) are substantially reduced or completely eliminated when discharged from the showerhead 19.

In a like manner, when a rapid pressure drop occurs in the water pressure flowing through the shower arm 17 into the bottle 22, the compressed air within the bottle 22 expands immediately, maintaining an almost constant water pressure through the showerhead 19 leaving a user unaware that a pressure change occurred. Once the water pressure rises again, the air is slowly recompressed. From the foregoing, those skilled in the art would understand that if the converse occurs, with a sharp pressure surge, the water within the bottle 22 acts as a cushion, absorbing the higher pressure.

It should also be understood by those skilled in the art that when an air spurt occurs, which sometimes happens in older high rise buildings on upper floors, the air bubbles are received within the reservoir of water in the bottle 22 and broken up as fast moving eddies, and aerated toward the showerhead 19 or absorbed into the air space volume of the bottle 22 without user detection. Also, if enough air spurts were to occur to lower the water level within the reservoir near the mouth of the extension member 34, a series of small holes, such as the hole H disposed in the lower portion of the tube member 34 (FIG.2), will allow the air to escape as a stream of small bubbles rather than overwhelming the extension tube 34 with a large bubble to cause its own air spurt from the showerhead 19.

From the foregoing it should be understood that the shower retrofit kit 10 provides an easily installable, affordable solution to long standing inconvenience, which for the very young and the elderly could be a serious hazard issue.

In situations where the shower retrofit kit 10 is installed in series with a bathtub showerhead, commonly called an inverting spigot, which is pulled to use the shower instead of the bathtub water outlet, the bottle 22 should be installed below the height of the bathtub spigot, otherwise the unit will drain noisily after each use.

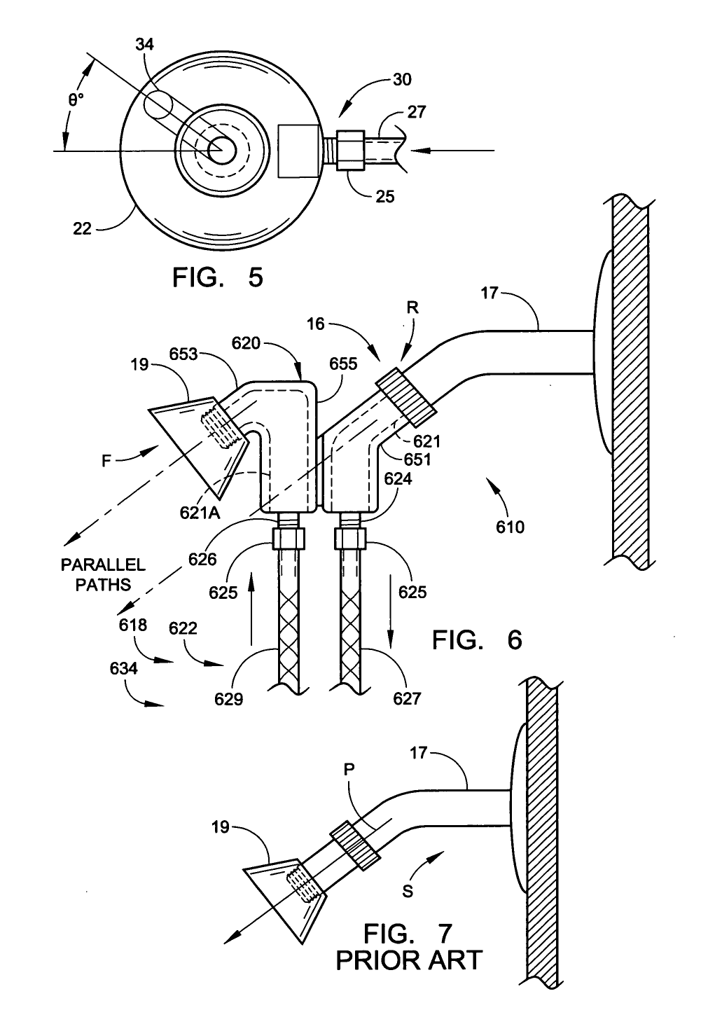

It should also be noted that the position of the distal end D of the extension tube 34 relative to the bottom of the bottle 22 is adjustable depending upon the desired degree of protection from water pressure and water temperature surges. In this regard, the higher the distal end D of the extension tube 34 is from the bottom of the bottle 22, the less air will be trapped and therefore, the less air will be available to act as a cushion. On the other hand, the closer the distal end D of the extension tube 34 is to the bottom of the bottle 22 the less the available water volume for helping to absorb water temperature changes. In this preferred embodiment, the distal end D of the tube 32 is positioned at about a distance 2H from the bottom of the bottle 22, which is best seen in FIG. 2, where the distance H is approximately the distance from the bottom of the bottle 22 to the midpoint of the inlet 30 or incurrent path for water entering the bottle 22. It should also be noted that in this preferred embodiment of the present invention, the distal end D of the extension tube 34 should be positioned off center from the inlet 30 by about θ degrees as best seen in FIG. 5, to encourage eddies which will better mix the water. In this regard, θ is between about 5 degrees and 45 degrees, and most preferably, θ is about 30 degrees.

Considering now the water diverter 20 in greater detail with reference to FIG. 3, the water diverter 20 has an irregular shape which causes the threaded stubs 24 and 26 respectively to be spaced from one another in parallel alignment. This alignment allows the hoses 27 and 29 to be placed in straight-line connections with the bottle inlet 30 and the bottle outlet 32 respectively and also assures that the water paths between the coupler 20 and the bottle 22 will not be constricted.

Another important feature of the water diverter 20 is found in the threaded stub 28, which is dimensioned for receiving thereon the showerhead 19. In this regard, the stub 28, extends away from the left face of the front portion F and downward therefrom at an offset angle that substantially corresponds to the downward angle of the shower arm 17. In this manner, the flow of water from the showerhead 19 is maintained at the same angle and approximately at the same height as though the retrofit kit 10 had not been installed.

Although in this preferred embodiment the stubs 24 and 26 are described as threaded male stubs to accommodate the nut couplers 25 disposed on the hoses 27 and 29 respectively, it should be understood by those skilled in the art that the coupling arrangement between the coupler stubs 24 and 26 and hoses 27 and 29 could be reversed. In this regard, the hoses could be adapted with male threaded ends and the coupler stubs 24 and 26 could have finger engagable attachments with female receptacles, similar to the finger engagable attachment 42 and female receptacle 23. There is therefore no intention of limiting this preferred embodiment of the present invention to the precise description as provided.

Considering now the container 22 in greater detail with reference to FIGS. 2-3, the container 22 has a thin-walled construction composed of a pliable resilient material, such as polyvinylchloride. This construction permits the sidewalls of the container 22 to expand outward under pressure, which in turn, enables the interior volumetric space of the container 22 to slightly expand under pressure. This is an important aspect of this preferred embodiment of the present invention as the ability of the container 22 to expand allows the air space within the container 22 to absorb pressure changes from spurts of air that enter its interior space. The container 22 has a unitary construction, which generally comprises a base 62, a cylindrical thin-walled body portion 63 and a narrow top portion 64, which terminates in a threaded neck 65, which is adapted to receive thereon a cap 66.

The cap 66 has a centrally disposed threaded hole 68 for receiving therein the extension tube 34, which extends downwardly into the interior of the container 22. The extension tube 34 as best seen in FIG. 2 has a threaded proximal end P, which is dimensioned to engage and be attached to the threaded coupler 25, disposed on the proximal end of hose 29.

Considering now the cap 66 in greater detail with reference to FIG. 2, the cap 66 includes an outer depending continuous, preferably annular skirt 67. The annular skirt 67 has an outer surface and an inner surface. The inner surface is provided with a continuous helical thread, which is engageable with the threads (not shown) provided upon the exterior surface of the neck 65 of the bottle 22 to which the cap 66 is to be secured.

As best seen in FIG. 2, the threaded hole 68 permits the extension tube 34 to be threadably secured within the hole 68 and then locked in place with the locking nut 25. In this manner, the distance the extension tube 34 extends within the bottle 22 can be adjusted to cause different affects to be achieved. More particularly, when the water level within the bottle 22 extends above the distal end D of the extension tube 34, the interior of the bottle 22 is sealed from atmospheric communication with the atmospheric air. In this manner, when the pressure exerted by the liquid against the air captured within the bottle 22, the counter pressure force causes the liquid to move out of the bottle 22 via the extension tube 34 at an equalize water pressure force equal to the water pressure entering the bottle 22 via the inlet 30.

Referring now to the drawings and more particularly to FIG. 4, there is shown another retrofit kit 410, which is constructed according to another preferred embodiment of the present invention. The kit 410 generally comprises a showerhead 419, a showerhead mounting bracket 421, mounting hardware 423, a plastic container or expandable bladder 422 having a sealing cap 466 with a centrally disposed threaded inlet or aperture 468, a pair of coupling members 427 and 429 respectively, an adjustable threaded extension tube 434 which is adapted to be threadably received within the threaded aperture 468 and a locking nut 470 which is adapted to be received on the threaded distal end of the extension tube 434 to lock or secure the extension tube 434 in place against the cap 466.

The coupling member 427 has a locking nut 425 on one of its ends to secure the coupling member 427 to a threaded water inlet 430 disposed in a lower half portion of the expandable/bladder 422. The other end (not shown) of the coupling member 427 is adapted to be secured to a faucet outlet, such as a bathtub faucet outlet or outdoors faucet outlet (not shown) in order to supply the bladder 422 with a source of water under pressure. In a similar manner, the coupling member 429 includes on its distal end another locking nut 425, which is adapted to be secured to a threaded inlet 426 of the showerhead 419. The opposite end of the coupling member is adapted to be secured by pushing it onto the distal end of the extension tube 434 as best seen in FIG. 4. In this regard, the free end of the coupling member 429 is dimensioned to be push onto the threaded end of the extension tube 434 to form an airtight, and watertight seal.

Although in this preferred embodiment of the present invention, the kit 410 is illustrated with mounting hardware 423 in the form of screws, it will be understood by those skilled in the art that the mounting bracket 421 could also be attached to a surface wall W by use of an adhesive, bolts and nuts, or nails to name but a few different types and kinds of attaching means. There is no intention therefor of limiting the manner of attaching the mounting bracket 421 to only screws, as other means of attachment are contemplated within the true scope and intent of this preferred embodiment.

As best seen in FIG. 4, the distal end of the extension tube 434 has a sufficient threaded length to adjust the spacing relationship between the proximal end of the extension tube, indicated generally at PE and an imaginary horizontal line passing through the center of the inlet 430. In this regard, when the extension tube 434 is disposed at twice the distance (2H) from the bottom of the bladder 422 as the imaginary horizontal line passing through the center of the inlet 430, the extension tube 434 can be raised by % H or lowered by % H to cause a ratio change between the air volume and water volume within the bladder. That is, the higher the distal end of the extension tube 434 is raised from the bottom of the bladder 422, the smaller the captured air volume is to the captured water volume. Conversely, the lower the distal end of the extension tube is lowered toward the bottom of the bladder 422, the smaller the captured water volume is to the captured air volume.

Stated a little differently, the threaded end portion of the extension tube, indicated generally at 435, has a sufficient length to allow the distance that the distal end of the extension tube 434 is spaced from the bottom of the bladder 422 to be adjusted. In this manner, water under pressure may be accumulated within the bladder 422 and then discharged from the interior of the bladder 422 via the extension tube 434 once the water level within the bladder 422 is sufficiently deep to cover the proximal end of the extension tube 434 as best seen in FIG. 4. This is an important feature of this preferred embodiment of the present invention as the height of the proximal end of the extension tube 434 from the base 462 of the bladder 422 controls the desired amount of protection from pressure variations. In this regard, the higher the tube opening at the distal end of the tube 434 is from the base 462, the less air will be trapped in the space above the water line of water captured within the bladder 422, and therefore the less air will be available to cushion in rushes of air from the water source. Conversely, the closer the distal end D of the extension tube 434 is positioned relative to the base 462, the less accumulated water will be available for dilution of hot or cold water spikes entering from the water source. Based on these considerations, in this preferred embodiment, the proximal end of the extension tube 434 should be placed at about the same height distance H as the inlet 430 is disposed from the bottom 462 of the bladder 422. Expressed empirically, the inlet would be disposed at a distance H from the bottom 462 of the bladder 422, which the proximal end of the extension tube 434 would be disposed at a distance 2H from the bottom 462 of the bladder 422. This adjustment aspect of this preferred embodiment of the present invention is important to make adjustments for spurts of air in the water source lines and to make adjustments for rapid changes in the temperature of the water in the water source line.

Referring now to the drawings and more particularly to FIG. 6, there is shown another retrofit kit 610, which is constructed according to another preferred embodiment of the present invention. The kit 610 is substantially identical in construction to retrofit kit 10 except that it includes a showerhead coupler 620, which has a different configuration or construction than that of showerhead coupler 20.

As best seen in FIG. 6, the retrofit kit 610 includes a buffering arrangement 618 that includes a reservoir unit 622 with an extension tube 634 and a pair of linking units 627 and 629, which enables the reservoir unit 622 and extension tube 634 (which are substantially identical in construction to container 22 and extension tube 34 respectively) to be placed in-line with the showerhead coupler 620. All other parts of the retrofit kit 610 are the same as retrofit kit 10, and therefore any component parts which have already been described in detail with reference to retrofit kit 10, will not be described hereinafter in greater detail.

Considering now the showerhead coupler 620 in greater detail with reference to FIG. 6, the showerhead coupler 620 has a unitary construction and is composed of molded plastic, The coupler has a V-shaped right side member 651 and a V-shaped left side member 653 which are integrally connected by a separating wall indicated generally at 655. The right side member 651 includes an incurrent fluid path 621, which extends from a water source inlet at a rear portion R of the coupler 620 to a threaded outlet indicated generally at 624. The left side member 653 includes an excurrent fluid path 621A, which extends from a water source outlet at a front portion F of the coupler to a threaded inlet indicated generally at 626.

In the preferred embodiment, the retrofit kit 10 has been described as not including the shower stall shower arm 17 or the shower stall showerhead 19. However, it is contemplated the retrofit kit could include the shower arm 17 and the showerhead 19 so that the kit 10 provides all new exterior shower stall components. Also in the preferred embodiment, the retrofit kit 10 has been described as being installed in the exterior portion of the shower stall. However, it is also contemplated that the retrofit kit 10 could also be installed as part of a new construction or remolding effort within an interior space behind a water closet wall, such as the wall W. In this case, the extension tube 34 would have a fixed length for the type of remodeling being accomplished. In other words, a fixed length to compensate for air spurts or a different fixed length to compensate for water pressure and water temperature fluctuations. Therefore, while a particular embodiment of the present invention has been disclosed, it is to be understood that various different modifications are possible and are contemplated within the true spirit and scope of the appended claims. There is no intention, therefore, of limitations to the exact abstract or disclosure herein presented.

I claim:

1. A retrofit kit, comprising:
a fluid path diverter having an incurrent fluid path and an excurrent fluid path, wherein said incurrent fluid path and said excurrent fluid path are not in fluid communication with one another; and
a reservoir for buffering fluid fluctuations and for placing said incurrent fluid path and said excurrent fluid path in fluid communication with one another.

2. The retrofit kit according to claim 1, wherein said reservoir is a container having another incurrent fluid path and another excurrent fluid path, wherein said another incurrent fluid path and said another excurrent fluid path are in fluid communication with one another.

3. The retrofit kit according to claim 2, wherein said container is a sealed container having supported therein from above a fluid distributor that facilitates establishing an air to water volume ratio within a fluid receiving volumetric space defined by said container.

4. The retrofit kit according to claim 3, wherein said fluid distributor is an adjustable distributor for facilitating changing said air to water volume ratio.

5. The retrofit kit according to claim 4, wherein said sealed container is a thin-walled flexible container and includes a cap having a centrally disposed threaded aperture; and
wherein said adjustable distributor is an elongated extension tube having a proximal end with a plurality of spaced apart air vent holes and a threaded distal end dimensioned to be threadably received within said aperture to position and hold said proximal end at a desired distance from the bottom of said container to help facilitate establishing said air to water volume ratio within said fluid receiving volumetric space defined by said container as fluid passes therethrough.

6. The retrofit kit according to claim 4, wherein said container includes an incurrent coupler for linking said incurrent fluid path to said another incurrent fluid path and an excurrent coupler for linking said excurrent fluid path to said another excurrent fluid path; and
wherein said incurrent fluid path and said excurrent fluid path are parallel to one another to help make the effect of said fluid diverter transparent to a user.

7. A shower stall kit, comprising:
showerhead coupling means adapted to be disposed between a shower arm and a shower head and having a water source outlet and a water source inlet, wherein said water source outlet and said water source inlet are not in fluid communication with one another;
sealed water chamber means adapted to be coupled to said shower head coupler means and having a side wall inlet and a top wall outlet wherein said side wall inlet and said top wall outlet are in fluid communication with one another through a volumetric space; and
wherein said sealed water chamber means is further adapted to be coupled between said water source outlet and said water source inlet to help facilitate the even discharge of a source of water under pressure from said shower arm to said shower head through said volumetric space.

8. A method of using a shower stall kit, comprising:
attaching a showerhead coupler between a shower arm and a showerhead, said showerhead coupler having a water source outlet and a water source inlet, wherein said water source outlet and said water source inlet are not in fluid communication with one another;
attaching a sealed water chamber to said shower head coupler, said sealed water chamber having a side wall inlet and a top wall outlet wherein said side wall inlet and said top wall outlet are in fluid communication with one another through a volumetric space; and
wherein said step of attaching includes:
coupling said water source outlet to said side wall inlet; and
coupling said top wall outlet to said water source inlet.

9. A kit for helping to facilitate the even discharge of a source of water under pressure from a shower arm to a showerhead, comprising:
a water directing attachment for securing between the shower arm and the shower head to break the direct water flow path between the shower arm and the shower head, said water directing attachment having a fluid path from the shower arm to a water source outlet and another fluid path from the shower head to a water source inlet, wherein the water source outlet and the water source inlet are not in fluid communication with one another;
a flexible thin walled bottle having a fluid receiving inlet and a fluid discharge outlet, said flexible thin walled bottle further having a sufficient volume capacity and a sufficient flexibility for helping to smooth out momentary fluctuations of water pressure changes from a source of water discharged into said bottle;
a flexible conduit for establishing a water path from said water source outlet disposed at said water directing attachment to said fluid receiving inlet disposed at said thin walled bottle;
another flexible conduit for establishing another water path from said fluid discharge outlet disposed at said thin walled bottle to said water source inlet disposed at said water directing attachment; and
a sealing cap coupled to said another flexible conduit for sealing said flexible thin walled bottle from atmospheric pressure and for helping to extend said another water path to a volumetric space disposed within said bottle.

10. The kit according to claim 9, wherein said water directing attachment includes a pair of V-shaped elbow members integrally attached to one another through a common dividing wall, said common dividing wall helping to break the direct water flow path between the shower arm and the shower head.

11. The kit according to claim 9, wherein said water directing attachment includes a V-shaped elbow member and a straight line member integrally attached to one another through a common dividing wall, said common dividing wall helping to break the direct water flow path between the shower arm and the shower head.

12. The kit according to claim 9, further comprising:
a set of installation instructions; and
a roll of sealing tape.

13. The kit according to claim 9, further comprising:
a showerhead; and
a shower arm.

14. A showerhead compensator, comprising:
a showerhead mount for supporting a showerhead in a position above an outlet source of fluid under pressure;
a reservoir disposed below said outlet source, said reservoir having bottom floor, a reservoir inlet coupled to said outlet source, and a reservoir outlet;
a closure for sealing said reservoir outlet to prevent the escape of air and water therefrom;
an extender passing through said closure for providing a passageway into a volumetric space defined by said reservoir;
said extender having a distal end disposed above said reservoir outlet and a proximal end disposed below said reservoir outlet, wherein the proximal end of said extender is disposed at about twice the distance from said bottom floor as said water inlet;
a elongated coupler for extending a water tight passageway from the distal end of said extender to said showerhead to facilitate the discharge of water under pressure from said showerhead;
wherein said water reservoir has a sufficient volume capacity for mixing water of substantially different temperatures to allow the different temperature waters to rapidly achieve an average water temperature for discharge to said showerhead; and
wherein said closure and said reservoir outlet cooperate with one another to provide a air-tight seal to sufficiently compress any air captured above the proximal end of said extender to cause water flowing under pressure into said reservoir to be force out said water tight passageway and discharged by said showerhead.

15. The showerhead compensator according to claim 14, wherein said water reservoir further has a sufficient volume capacity for absorbing uneven spurts of water under pressure so that they are unnoticed when discharged from said showerhead.

16. The showerhead compensator according to claim 15, wherein said extender is offset from said reservoir inlet by about θ degrees.

17. The showerhead compensator according to claim 16, wherein a preferred θ degrees is between about 5 degrees and about 45 degrees.

18. The showerhead compensator according to claim 16, wherein a preferred θ degrees is about 30 degrees.

19. The showerhead compensator according to claim 16, wherein the distance from the distal end of said extender relative to the bottom of said reservoir is an adjustable distance to allow more or less water to be stored in said reservoir before being discharge under pressure to said showerhead.

20. The showerhead compensator according to claim 15, wherein said elongated coupler is a push on coupler that is received on the distal end of said extender forming an airtight seal therewith.

21. A shower apparatus, comprising:
a showerhead coupler disposed between a shower arm and a showerhead;
said showerhead coupler having an incurrent fluid path and an excurrent fluid path wherein said incurrent fluid path and said excurrent fluid path are not in fluid communication with one another and wherein said incurrent fluid path and said excurrent fluid path include parallel segments for helping to maintain a substantially unmodified fluid discharge path from said showerhead; and
a buffering arrangement for helping to make fluid fluctuations in an otherwise steady state flow of fluid along said excurrent fluid path unnoticeable to a showerhead user and for placing said incurrent fluid path and said excurrent fluid path in fluid communication with one another.

22. A compensator for controlling water discharging, comprising:
a water path coupler having an incurrent fluid path and an excurrent fluid path wherein said incurrent fluid path and said excurrent fluid path are not in fluid communication with one another; and
a buffering arrangement for placing said incurrent fluid path and said excurrent fluid path in fluid communication with one another to complete a water discharge path from said coupler and for helping to make temperature fluctuation spikes in an otherwise steady fluid substantially undetectable in water discharging from said coupler.

23. The compensator according to claim 22, wherein said water path coupler and said buffering arrangement are disposed in close proximity to a water closet but not in said water closet for helping to control water discharging from a water outlet into said water closet.
